(19) United States
(12) Patent Application Publication
(10) Pub. No.: US 2024/0104353 A1
(43) Pub. Date: Mar. 28, 2024

(54) SEQUENCE-TO SEQUENCE NEURAL NETWORK SYSTEMS USING LOOK AHEAD TREE SEARCH

(71) Applicant: DeepMind Technologies Limited, London (GB)

(72) Inventors: Rémi Bertrand Francis Leblond, Cachan (FR); Jean-Baptiste Alayrac, London (GB); Laurent Sifre, Paris (FR); Miruna Pîslar, Paris (FR); Jean-Baptiste Lespiau, London (GB); Ioannis Antonoglou, Cambridge (GB); Karen Simonyan, London (GB); David Silver, Hitchin (GB); Oriol Vinyals, London (GB)

(21) Appl. No.: 18/274,748

(22) PCT Filed: Feb. 8, 2022
(86) PCT No.: PCT/EP2022/053035

§ 371 Date: Jul. 28, 2023

(30) Foreign Application Priority Data
Feb. 9, 2021 (GR) 20210100088

(51) Int. Cl. G06N 3/0455

(52) U.S. Cl. CPC G06N 3/0455

(57) ABSTRACT

A computer-implemented method for generating an output token sequence from an input token sequence. The method combines a look ahead tree search, such as a Monte Carlo tree search, with a sequence-to-sequence neural network system. The sequence-to-sequence neural network system has a policy output defining a next token probability distribution, and may include a value neural network providing a value output to evaluate a sequence. An initial partial output sequence is extended using the look ahead tree search guided by the policy output and, in implementations, the value output, of the sequence-to-sequence neural network system until a complete output sequence is obtained.

### BACKGROUND

This specification relates to neural network systems for sequence transduction, that is for converting one sequence to another sequence.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes sequence transduction neural network systems, implemented as one or more computer programs on one or more computers in one or more locations, that accept an input sequence and provide an output sequence. Many real-world problems can be addressed by such systems.

Thus there is described an example of a computer-implemented method, and a corresponding system, for generating an output token sequence from an input token sequence by combining a look ahead tree search, such as a Monte Carlo tree search, with a sequence-to-sequence neural network system. The sequence-to-sequence neural network system has a policy output defining a next token probability distribution, and may include a value neural network providing a value output to evaluate a sequence. An initial partial output sequence is extended using the look ahead tree search guided by the policy output and, in implementations, the value output, of the sequence-to-sequence neural network system until a complete output sequence is obtained. An example of a technique for training a value neural network is also described.

Particular embodiments of the subject matter described in this specification can be implemented so as to realize one or more of the following advantages.

Some implementations of the described system and method are able to perform sequence transduction in a way which allows the sequence transduction process to be better adapted to complex tasks. For example, as opposed to only producing output sequences with a high sequence-model likelihood, implementations of the system can generate output sequences that aim to generate high scores for a particular, chosen sequence transduction metric.

Sequences with a high likelihood are not necessarily the most useful sequences in practice, and according to theory training a model based on maximum likelihood can produce sub-optimal results. Implementations of the described system can perform better than some previous techniques in many real-world applications. More specifically, implementations of the system can produce output sequences with higher values according to a wide range of metrics.

The system is not limited to using any particular metric, and a metric can be selected according to the types of output sequence that are desired. The system can be used to generate accurate output sequences according to a particular metric, or it may be used to generate output sequences that are characterized by their diversity, or to output sequences that are characterized by the presence or preponderance of particular, desirable characteristics or by the absence or relatively reduced likelihood of undesirable characteristics.

In some implementations the look ahead tree search may be used to modify a distribution of output sequences generated e.g. by training the value neural network using a different or additional objective to that used for training the policy for selecting tokens. For example, where the tokens represent text for machine translation the system may be used to improve the output text generated so that it appears more natural to a human, e.g. by selecting a particular sequence transduction metric, even when the result may be objectively less accurate according to some other metrics. A particular example of a useful type of metric, an “unprivileged” metric, is also described.

Some implementations of the system can generate accurate sequences with less computing and memory requirements than are needed by some other approaches. In particular some implementations of the described system and method are specifically adapted to hardware acceleration, to enable rapid sequence-to-sequence processing.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a system that is configured to receive and process an input sequence to generate an output sequence.

FIG. 2 shows a process for generating an output sequence from an input sequence using a look ahead search guided by a sequence-to-sequence neural network system.

FIG. 3 shows a process for training a value neural network

FIG. 4 illustrates an example value neural network training process.

FIG. 5 illustrates comparative performance of neural machine translation systems.

Like reference numbers and designations in the various drawings indicate like elements.

### DETAILED DESCRIPTION

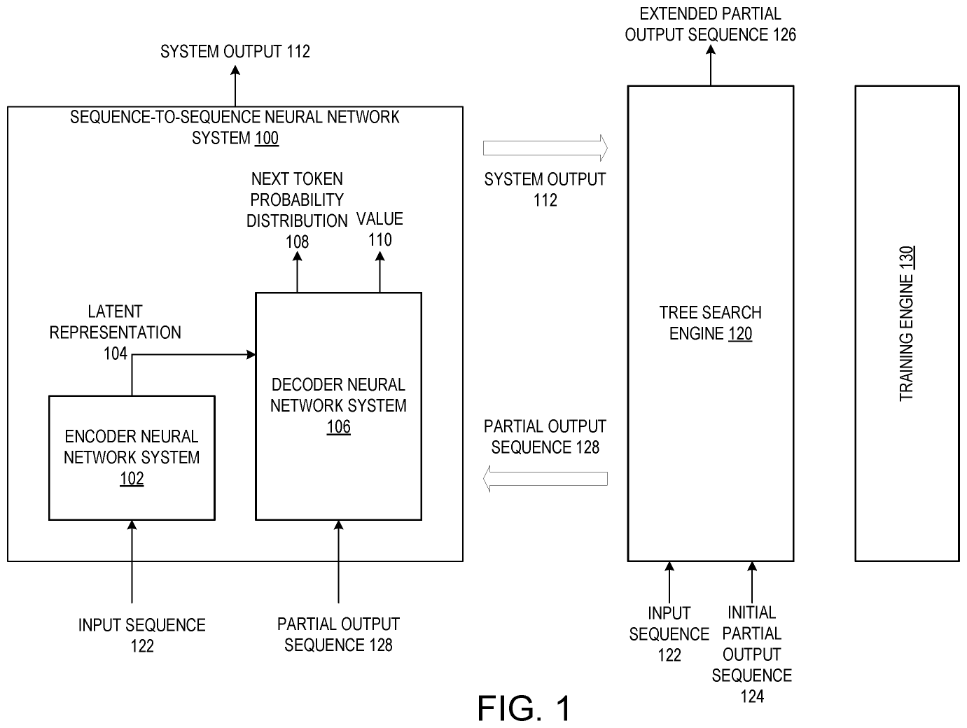

FIG. 1 shows an example of a system that may be implemented as one or more computer programs on one or more computers in one or more locations and that is configured to receive an input sequence and to process the input sequence to generate an output sequence.

The input sequence comprises a sequence of input tokens and the output sequence comprises a sequence of output tokens. Merely as one example, the neural network system may be a neural machine translation system. Then the input tokens may represent words in a first natural language and the output tokens may represent words in a second, different natural language. That is, if the input sequence represents a sequence of words, such as a sentence or phrase, in an original natural language, the output sequence may be a translation of the input sequence into a target natural language. The tokens may include an end of sequence (EOS) token.

The system comprises a sequence-to-sequence neural network system 100 and a tree search engine 120. During training the system also includes a training engine 130; this is not needed after training.

The sequence-to-sequence neural network system 100 is configured to receive a system input comprising an input sequence 122 and a partial output sequence 128. The input sequence comprises a sequence of input tokens. The partial output sequence includes zero, one, or more output tokens.

The sequence-to-sequence neural network system 100 is configured to process the system input to generate a system output 112 comprising a next token probability distribution 108 over possible output tokens for a next output token that extends the partial output sequence 128. For example the next token probability distribution may comprise a set of scores defining probabilities of possible next output tokens.

In implementations the system output 112 also comprises a scalar value or score 110 that evaluates the partial output sequence 128. The system output 112 may define the value directly, or it may define a probability distribution over possible values and the value or score may be determined by sampling from the distribution. As used hereafter, generating a value may refer to either approach. The value may comprise a sequence transduction metric i.e. a metric of transduction of the input sequence 122 to the partial output sequence 128. More specifically the value may approximate a final sequence transduction metric, or score, that would be expected to be obtained if the partial output sequence were continued to complete the output sequence based on a token selection policy defined by successive next token probability distributions 108.

The tree search engine 120 is configured to perform a look ahead tree search using the input sequence 122 to extend an initial partial output sequence 124 to provide an extended partial output sequence 126. The extended partial output sequence 126 is then used as the next initial partial output sequence 124. Thus the tree search engine 120 iteratively extends the initial partial output sequence, e.g. starting from a null output sequence with no output tokens, until a complete output sequence is generated. The complete output sequence is generated autoregressively, one output token at a time, using a look ahead tree search based on a previously generated partial output sequence. In implementations the tree search engine is configured to perform a Monte Carlo tree search.

The tree search engine 120 uses the sequence-to-sequence neural network system 100 to guide the look ahead search. More particularly the next output token is selected by the tree search engine 120 using the next token probability distribution to guide a look ahead search, in particular when expanding a search tree. During the look ahead tree search the tree search engine 120 provides the partial output sequence for a node, e.g. a leaf node of the tree, to the sequence-to-sequence neural network system 100, and receives back the system output 112 for the partial output sequence.

The training engine 130 is used to train the sequence-to-sequence neural network system 100 e.g. as described later, and is not needed thereafter. In general the sequence-to-sequence neural network system 100 used by the tree search engine 120 is a previously trained system.

In some implementations the sequence-to-sequence neural network system 100 comprises an encoder neural network system 102 coupled to a decoder neural network system 106. The encoder neural network system 102 is configured to process the input sequence 122 to generate a latent representation 104 of the input sequence 122. The decoder neural network system 106 is configured to process the latent representation 104 in combination with the partial output sequence 128 to generate the system output 112. In some implementations the partial output sequence 128 may be shifted one step to the right i.e. with the first token at position two.

In some implementations, but not essentially, the encoder neural network system 102 includes a transformer neural network subsystem, i.e. a neural network subsystem including one or more transformer blocks or self-attention layers. A transformer block typically includes an attention or self-attention neural network layer followed by a feedforward neural network. An attention, or self-attention, neural network layer is a neural network layer that includes an attention, or self-attention, mechanism (that operates over the attention layer input to generate the attention layer output). A self-attention mechanism may be masked so that any given position in an input sequence does not attend over any positions after the given position in the input sequence. There are many different possible (self-) attention mechanisms. Some examples of transformer blocks including attention mechanisms, are described in Vaswani et al. “Attention is all you need”, 31st Conference on Neural Information Processing Systems (NIPS 2017), Long Beach, CA, USA.

Similarly in some implementations, but not essentially, the decoder neural network system 106 includes a transformer neural network subsystem. The latent representation 104 may be processed by the decoder neural network system 106 using one or more cross-attention layers i.e. attention layer(s) that operate between the encoder and decoder e.g. using an attention mechanism that includes an input from the latent representation 104.

In implementations the system input, in particular the input tokens and the output tokens of the system input, are represented by embeddings i.e. by any ordered collection of numerical of values such as a vector. A token embedding can be generated as the output of a neural network that processes the token. As another example, where the tokens represent words, a d-dimensional vector embedding for each word of a vocabulary may be defined by an embedding matrix with d columns. Thus the encoder neural network system 104 and the decoder neural network system 106 may include an initial, embedding-determining stage.

In implementations each token of the input sequence 122 for the encoder neural network system 104, e.g. each embedding of a token, may be combined with an embedding of a position of the token in the sequence, e.g. by summation. Similarly each token of the partial output sequence 128 for the decoder neural network system 106, e.g. each embedding of a token, may be combined with an embedding of a position of the token in the sequence. One way of determining a position embedding vector is described in Vaswani et al. (ibid).

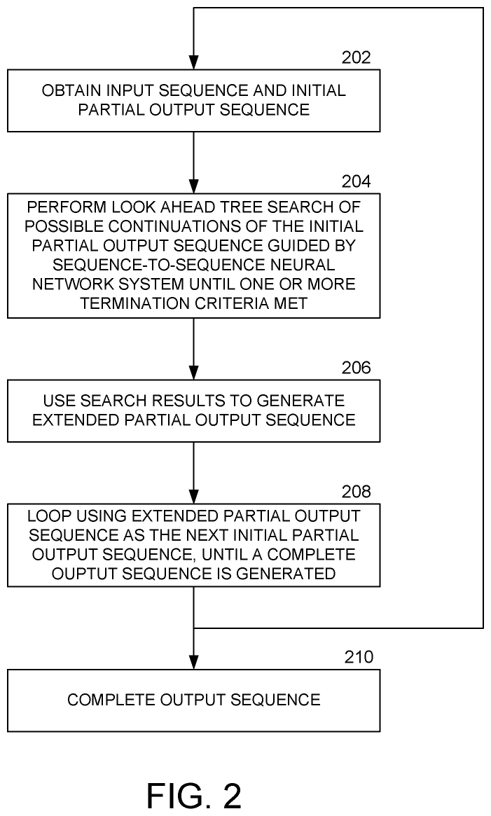

FIG. 2 shows an example process for generating an output sequence from an input sequence using a look ahead search guided by a sequence-to-sequence neural network system. The process of FIG. 2 may be implemented by one or more appropriately programmed computers in one or more locations.

The process obtains an input sequence as previously described, and an initial partial output sequence e.g. a null sequence (step 202).

The process then performs a look ahead tree search, e.g. a Monte Carlo tree search, of possible continuations of the initial partial output sequence, guided by the system output 112 of the sequence-to-sequence neural network system 100, e.g. until one or more termination criteria are met (step 204). For example the look ahead tree search may be an in-tree search and a termination criterion may be that a leaf node (an unopened node) is encountered, or a termination criterion may depend on a search budget e.g. a budget number of search steps, or a termination criterion may depend on one or more complete output sequences being generated.

The results of the look ahead tree search are used to generate the extended partial output sequence 126, e.g. as described later (step 206). For example, the process may select one of the possible continuations using the look ahead tree search to extend the initial partial output sequence. The extended partial output sequence may then be further extended, by performing another look ahead tree search of possible continuations of the extended partial output sequence guided by the sequence-to-sequence neural network system.

Thus in implementations the process loops, using the extended partial output sequence 126 as the next initial partial output sequence 124 (step 208). The process may iteratively extend the partial output sequence by performing successive look ahead tree searches until a complete version of the output sequence is generated (step 210).

In some implementations the process generates a search tree probability distribution over the possible continuations of the initial partial output sequence using the look ahead tree search. The process then selects a continuation of the initial partial output sequence, i.e. a next output token, from the possible continuations using the search tree probability distribution. For example the next output token may be the token with the highest value according to the search tree probability distribution. In some implementations the search tree probability distribution depends on statistics of child nodes of a root node, where the root node represents the initial partial output sequence and the child nodes its different possible continuations.

In some implementations the look ahead tree search is also guided by the value 110, generated by a value neural network configured to evaluate nodes of the tree. A node of the tree represents one of the possible continuations of the initial partial output sequence, i.e. a candidate continuation of the sequence.

The value neural network processes the candidate continuation represented by a node of the tree, i.e. a partial output sequence associated with the node, and may also process the input sequence, to generate a value for the node. Where the tree search engine 120 is configured to perform a Monte Carlo tree search the evaluated nodes comprise leaf nodes of the tree. The generated value 110 is used to guide the look ahead tree search.

In some implementations the value 110 and the next token probability distribution 108 are generated by a shared neural network, e.g. by separate heads on a common torso as shown in FIG. 1. That is, the value neural network may be part of the sequence-to-sequence neural network system 100. In some implementations the value 110 and the next token probability distribution 108 are generated by separate neural networks. Generating the value 110 and the next token probability distribution 108 using a shared neural network can significantly improve the generated values, in particular by reducing overfitting.

In implementations the value neural network is a previously trained neural network. That is, the value neural network has been trained prior to using it to evaluate nodes of the search tree. Where the value 110 and the next token probability distribution 108 outputs are generated by a shared neural network, these outputs may be (but need not be) trained jointly.

In implementations the sequence-to-sequence neural network system, more particularly the next token probability distribution 108, and the value neural network, more particularly the value 110, have been trained to optimize different objectives. More specifically the next token probability distribution 108, and the value 110, may each have been trained to optimize a different respective sequence transduction metric (although the specific objectives may match the respective forms of these two outputs).

For example an objective for the next token probability distribution 108 may comprise a sequence transduction metric based on ground truth pairings of input and output sequences. The objective may be based on the ground truth either directly, or indirectly e.g. if distilling an initial supervised policy i.e. if trained to match a policy itself trained using ground truth pairings of input and output sequences. An objective for the value 110 may comprise a different sequence transduction metric based on ground truth pairings of input and output sequences, or it may comprise a metric that does not rely on knowledge of the ground truth.

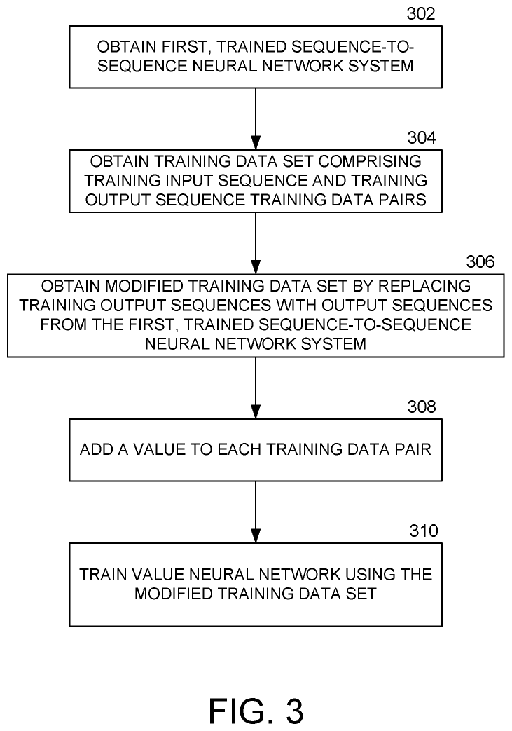

In general the next token probability distribution 108 and the value 110 are trained using training data pairs comprising a training input sequence and a training output sequence. Training the sequence-to-sequence neural network system 100, in particular the value neural network is described in more detail later with reference to FIG. 3.

There are many possible sequence transduction metrics that can be used depending on the application, e.g. on what the input sequence and output sequence represent. Two general types of sequence transduction metric are, as used herein, a “privileged metric” and an “unprivileged metric”. These are now described in the particular example context of machine translation, although they are also applicable in other contexts.

A “privileged metric” is computed between the ground truth output sequence associated with an input sequence, e.g. that represents a translation of the input sequence, and a model-generated output sequence for the input sequence. A privileged metric can e.g. be used to assess the quality of the model-generated output. A privileged metric does not rely explicitly on the input sequence, but rather on the associated ground truth sequence. Examples of privileged metrics include BLEU (Papineni et al., “Bleu: a method for automatic evaluation of machine translation”, Proc. 40th Annual Meeting of the Association for Computational Linguistics, 2002), and BERTScore (Zhang et al., arXiv:1904.09675).

An “unprivileged metric” is computed between the input sequence and a model-generated output sequence for this input sequence, or can be computed solely on the model-generated output. That is unprivileged metrics may or may not rely on the input sequence. For example for machine translation, human evaluation of the output sequence, or a learned metric based on a human evaluation of the output sequence, does not require the input sequence.

An unprivileged metric suitable for evaluating machine translations without requiring human input, referred to later as MLBERTScore, is now described: This metric is computed between the input sequence e.g. a source sentence and the model-generated output sequence, e.g. a translation of the sentence. An embedding is computed for each token in the input sequence and for each token in the output sequence using a multilingual language model e.g. using a BERT (Bidirectional Encoder Representations from Transformers) model, “BERT: Pre-training of Deep Bidirectional Transformers for Language Understanding”, Devlin et al., arXiv:1810.04805. Then a similarity measure e.g. a cosine similarity, is computed between all pairs of embeddings i.e. between embeddings of each token of the input sequence and each token of the output sequence. Then each token of one of the sequences, is aligned with a token of the other sequence, e.g. the input sequence with output sequence, or vice versa. This can be done by aligning tokens that have a maximum similarity measure. Then the similarity measures of the aligned tokens are combined, e.g. averaged, to determine the metric. This can have an advantage that it does not depend on human evaluation.

As previously described, in implementations the root node of a search tree of the look ahead tree search represents the initial partial output sequence. Child nodes of the search tree represent different possible continuations, that is edges to child nodes on a path from the root node each represent a candidate continuation of the initial partial output sequence. Performing the look ahead tree search may then comprise using the next token probability distribution 108 from the sequence-to-sequence neural network system 100 to expand the search tree, in particular to expand child nodes that are leaf nodes of the search tree. Generally a leaf node is an unexpanded node e.g. a node that has no child nodes of its own or that has a potential additional child node of its own.

A child node, e.g. a leaf node, may be expanded by processing the sequence of input tokens, the initial partial output sequence, and the candidate continuation of the initial partial output sequence represented by the child node, using the sequence-to-sequence neural network system. This generates a next token probability distribution 108 over possible next output tokens for a next output token to extend the candidate continuation of the initial partial output sequence. In implementations the next token probability distribution for a node need only be determined once for that node in any particular look ahead tree search. The probability, or score, for each possible next output token may be stored in the outgoing edges from the child (leaf) node.

One or more next output tokens may be selected to expand the search tree, e.g. by selecting a token with a highest probability or by sampling from the next token probability distribution 108, to add one or more new nodes. Selecting the next output token is referred to later as an “action”. The next output token may be selected from a vocabulary of possible tokens.

The look ahead tree search may also be guided by the value neural network. Generally this may be done by evaluating candidate continuations of the initial partial output sequence, represented by nodes of the look ahead tree search, by processing the candidate continuation of the initial partial output sequence represented by a node using the value neural network to determine a value for the node. More specifically, when expanding a leaf node the sequence-to-sequence neural network system 100 may process the sequence of input tokens, the initial partial output sequence, and the candidate continuation of the initial partial output sequence represented by the leaf node, to determine the value 110 for the leaf node as well as the next token probability distribution 108. The value for a leaf node may guide the look ahead tree search by updating the search tree probability distribution e.g. by updating action scores for edges between the leaf node and the root node. A particular example is described later.

In some implementations the sequence-to-sequence neural network system 100 does not generate the value 110.

In such implementations a complete output sequence may be determined by a single look ahead tree search e.g. starting from an initial partial output sequence comprising zero tokens. Then the look ahead tree search may be used to extend the initial partial output sequence, guided by the next token probability distributions from the sequence-to-sequence neural network system, until a complete output sequence is obtained. One of the tokens may be an end of sequence (EOS) token and an output sequence may be identified as a complete output sequence when an EOS token is added.

In some implementations of this type the value 110 is replaced by a value computed from the complete output sequence e.g. a score that is a metric of the complete output sequence, or of a combination of the input sequence and the complete output sequence. The look ahead tree search may be guided by this score instead of the value 110 from the sequence-to-sequence neural network system 100.

In some other implementations, that may but need not generate the value 110, the look ahead tree search may be used to determine a plurality of complete candidate output sequences, and then one of these may be selected as the true output sequence. For example each of the complete candidate output sequences may be scored, and a candidate output sequence may be selected based upon the scores e.g. by selecting a sequence with a maximum score, or selecting a sequence so that a sequence with a maximum score is relatively more likely to be chosen. The score may be any metric of the output sequence e.g. a metric of quality or diversity of the output sequence. The score may be a learned metric and/or it may comprise a sequence transduction metric as previously described.

The search tree comprises nodes connected by edges. In implementations the edges have edge data comprising an action score for the edge.

The action score for an edge may comprise a score for an action i.e. for adding an output token to a candidate continuation of the initial partial output sequence represented by the node. For example the action score may be an action-value, Q(s, a), depending on the state s represented by a node, and on an action a which defines one of the possible output tokens to be added to the partial output sequence represented by the node from which the edge extends. The action-value, Q(s, a), represents a value of taking action a in state s. The state sₜ, at a sequence transduction step t and represented by a corresponding node, may be defined as sₜ=(x, ŷ₁ . . . ŷₜ) where x is the sequence of input tokens and ŷ₁ . . . ŷₜ is the initial partial output sequence and the candidate continuation of the initial partial output sequence (where denotes an estimate of an output sequence token).

The edge data may also include a state-action visit count, N(s, a). This may be a count of the number of times action a, i.e. a particular token, has been taken from state s while building the search tree.

Performing the look ahead tree search may comprise traversing the search tree from the root node, by selecting edges to be traversed based on a combination of the action scores for the edges and the next token probability distributions. For example an edge, and hence an action and a next child node, may be selected based on an upper confidence bound e.g. a combination, such as a sum, of the action-value, Q(s, a), and value (U) that depends on a prior probability or score for the next token corresponding to the action π(a|s). The prior probability (that the action should be taken) may be determined by the sequence-to-sequence neural network system, e.g. the prior probability π(a|s) may be the next token probability distribution 108 for the node. The prior probability may be scaled by the visit count for the edge (which may itself be modified). Actions may be taken to maximize the sum of Q(s, a), and U.

As a particular example, performing the look ahead tree search may comprise recursively picking child nodes according to the formula below, starting at the root node, until a leaf node is reached:

$$a = arg {max}_{a ∈ 𝒜} ( Q ( s , a ) + c π ( a \vert s ) \frac{\sqrt{{\sum }_{b} N ( s , b )}}{1 + N ( s , a )} )$$

where c is a constant determining a level of exploration during the search and [symbol] is the set of possible actions (next tokens). In this example

$$c π ( a \vert s ) \frac{\sqrt{{\sum }_{b} N ( s , b )}}{1 + N ( s , a )}$$

is the upper confidence bound U(s, a). The prior probability, or “policy”, π(a|s), may be modified by a temperature parameter, τ, that balances exploration and exploitation of the search tree, e.g. in the above formula π(a|s) may be substituted by πᵣ(a|s)=π(a|s)^{1/τ}/Σ_{b}π(b|s)^{1/τ}. In some implementations the value of Q(s, a) may be rescaled to the interval [0,1] by replacing Q(s, a) with (Q(s, a)−minQ)/(maxQ−minQ).

In broad terms the search tree is traversed from the root node, iteratively selecting edges based on, e.g. that maximize, the combination of the action-value, Q (s, a), and the upper confidence bound U, until an unopened, i.e. not yet expanded, leaf node is encountered. This is then expanded by creating at least one new child node for the leaf node, each new child node representing a candidate extension of the candidate continuation of the initial partial output sequence.

The leaf node is evaluated using the value neural network to determine a leaf node value for the leaf node. A prior probability for each new edge from the leaf node to a new child node is determined using the sequence-to-sequence neural network system, i.e. from the next token probability distribution 108. For example the state represented by the leaf node, so, may be defined by the sequence of input tokens, the initial partial output sequence, and the candidate continuation of the initial partial output sequence represented by the leaf node. The leaf node may be expanded by determining π(a|s₀) for each possible action a, i.e. the prior probability at so for each token in the vocabulary of tokens; and by determining the value 110 of the state, v(s₀), as the leaf node value. The action score and visit count for each new edge may be initialized e.g. to set Q(s, a)=0 and N(s, a)=0.

The look ahead tree search may include a backup phase during which the edge data is updated based on the leaf node value. In implementations, after a leaf node has been expanded, the edge data for each edge traversed to reach the leaf node is updated using the value, v(s₀), for the leaf node. This may comprise updating the action scores for edges between the leaf node and the root node traversed during the search, using the leaf node value. A visit count for an edge may also be updated each time the edge is traversed during a search e.g. incremented by one.

In some implementations the action score e.g. action-value, Q (s, a), of each edge traversed is updated to a mean over the searches that included the edge, e.g. by determining a weighted average of the previous action-value, Q(s, a) with the leaf node value, v(s₀), e.g. according to

$$\frac{( visits \cdot Q ( s , a ) + v ( {s}_{0} ) )}{visits + 1}$$

where visits is the visit count. In some implementations the action score for an edge is updated to a value determined by a maximum value amongst tree searches involving the edge performed during the look ahead tree search. For example the action-value, Q (s, a) may be updated to a maximum of previous the action-value, Q(s, a) and the leaf node value, v(s₀). Updating to a maximum value in this way can provide improved sequence transductions, particularly when the value neural network (value 110), has been trained to optimize an unprivileged sequence transduction metric.

The search tree probability distribution may be determined from statistics of the child nodes of the root node, in particular from the edge data of the edges connecting the root node to its children. For example the search tree probability distribution may be determined from the visit counts, or from the action scores e.g. action-values Q(s, a) of the edges for the actions at the root node, or from both of these. The selected action, i.e. the selected next output token, may be the action (token) with the highest visit count, or the action (token) with the highest aggregated action score or action-value Q (s, a), where the aggregating involves taking the mean or maximum value over the searches that included the edge, as previously.

As previously described, each step of extending the partial output sequence involves repeating the look ahead search to produce another output token.

FIG. 3 shows an example process for training a value neural network, such as the value neural network that forms part of the sequence-to-sequence neural network system 100 of FIG. 1, e.g. for guiding a look ahead tree search as described above. The process of FIG. 3 may be implemented by one or more appropriately programmed computers in one or more locations.

The process initially obtains a first, trained sequence-to-sequence neural network system (step 302). The trained sequence-to-sequence neural network system may, but need not, have an architecture similar to the sequence-to-sequence neural network system 100 of FIG. 1.

For example, the trained sequence-to-sequence neural network system may be configured to receive a system input including an input sequence comprising a sequence of input tokens and optionally also a partial output sequence comprising zero, one, or more output tokens. The trained sequence-to-sequence neural network system may be configured to process the system input to generate a system output defining a next token probability distribution, “policy” πₛᵤₚ, over possible output tokens for a next output token to extend the partial output sequence.

The process also obtains a training data set comprising training data pairs, each training data pair comprising a training input sequence and a training output sequence (step 304). The training output sequence may be a ground truth transduction of the training input sequence. The training data set may have been used to train the first trained sequence-to-sequence neural network system, but this is not essential.

The process involves replacing at least some of the training output sequences in the training data set with output sequences sampled from the trained sequence-to-sequence neural network system (step 306). Here the process of generating an output sequence from an input sequence using the trained sequence-to-sequence neural network system is referred to as sampling; the sampling may be greedy sampling. Thus the process may involve, for each of at least some of the training data pairs, processing the training input sequence using the sequence-to-sequence neural network system to generate a sampled training output sequence, and replacing the training output sequence with the sampled training output sequence to obtain a modified training data set. In some other implementations instead of replacing the training output sequence with the sampled training output sequence the training output sequence is replaced by next-token probability distributions obtained at each step of sampling.

The process may then add a score, i.e. a value, for each training data pair of the training data set, e.g. based on a sequence transduction metric (step 308). For example the score may comprise a metric computed between the sampled training output sequence and the replaced (ground truth) training output sequence i.e. the metric may be a privileged metric. Or the score may comprise a metric computed between the sampled training output sequence and the training input sequence, or only on the sampled training output sequence i.e. the metric may be an unprivileged metric.

The value neural network may be configured to process the training input sequence and a partial training output sequence to generate a value for the partial output sequence. For example the value neural network may be part of a second sequence-to-sequence neural network system, e.g. the sequence-to-sequence neural network system 100 of FIG. 1. The process may train the value neural network using the modified training data set, to optimize an objective dependent upon the score, e.g. the sequence transduction metric, determined for each training data pair of the training data set (step 310).

In some implementations the value neural network is configured to process both the training input sequence and a partial training output sequence to generate a token prediction output for determining a next output token of the partial training output sequence. Then training the value neural network may include training the token prediction output using the training data pair. The value neural network can use the training input sequence and the training output sequence of a training data pair to learn to predict output tokens, which can help regularize the training of the value generated by the value neural network.

For example where the value neural network is part of a sequence-to-sequence neural network system that is configured to generate the value 110 and the next token probability distribution 108, the generated value may be trained using the value for each training data pair, and the next token probability distribution, π, may be trained to match the next token probability distribution output from the first, trained sequence-to-sequence neural network, πₛᵤₚ. For example the next token probability distribution, “policy” π, may be trained to optimize the objective D_{KL}(π|πₛᵤₚ), where D_{KL}(⋅) is the Kullback-Leibler divergence. In another approach the next token probability distribution output, π, may be trained using a negative log likelihood loss. This advantageously associates the learned values and the next token probability distributions used by the look ahead tree search to extend an output sequence.

The generated value may be trained using a regression or classification objective. For example an interval spanned by the score may be discretised into buckets and a cross-entropy loss may be used to train the generated value to predict the correct bucket e.g. a cross-entropy between a softmax distribution over the buckets (i.e. a probability for each bucket) and a one-hot encoding of the target value with the same dimension. In such implementations the value may be determined by multiplying the probability output by the softmax distribution for each bucket by the average value in each bucket and then summing the results.

Training the value neural network may comprise, for each training data pair, providing the training input sequence and a partial version of the sampled training output sequence to the value neural network, and accumulating a value generated by the value neural network to determine an accumulated value for the training data pair which relates to the complete (sampled) training output sequence. The method may then train the value neural network on a difference between the accumulated value and the sequence transduction metric for the training data pair. The previously mentioned self-attention (causality) mask may be applied during training (to ignore the future).

In implementations an architecture of the value neural network may be similar to or the same as that of the sequence-to-sequence neural network system 100. For example it may comprise an encoder neural network system e.g. including a transformer neural network subsystem coupled to a decoder neural network system e.g. including a transformer neural network subsystem.

In some implementations the value neural network may comprise two such encoder-decoder systems with shared weights. A first of these predicts the training output sequence a token at a time, e.g. autoregressively, and the second, more specifically the encoder of the second, receives the replaced (ground truth) training output sequence during its autoregressive prediction. The two systems are encouraged by a training loss to match their outputs. Each system also has a value prediction output which may be trained as previously described. Only the token prediction output of the first system is trained; the second system is only used during training, and after training the first system may be used as the value neural network.

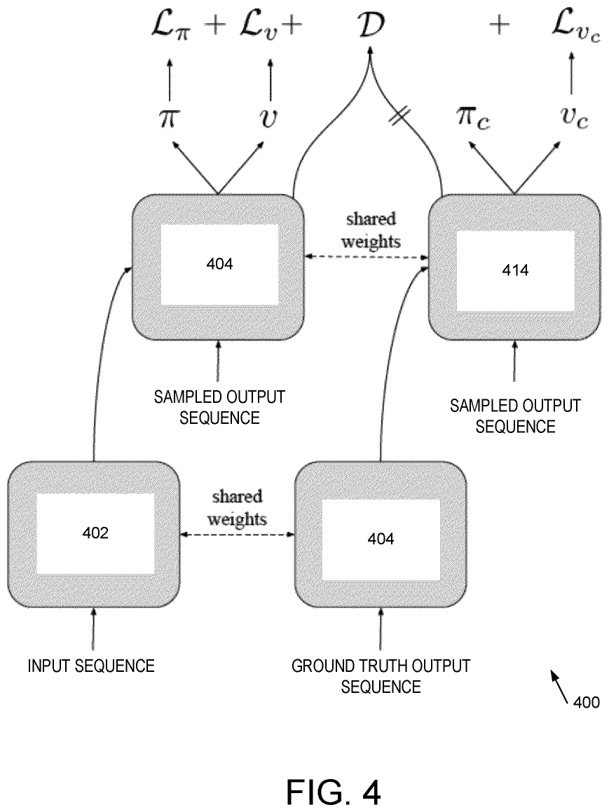

FIG. 4 illustrates an example value neural network 400 comprising first and second transformer neural network subsystem-based encoders 402, 412 and first and second transformer neural network subsystem-based decoders 404, 414. The first encoder-decoder system 402, 404 receives the training input sequence and the sampled training output sequence (step-by-step; and shifted right as previously described). The second encoder-decoder system 412, 414 receives the ground truth training output sequence and the sampled training output sequence (step-by-step; and shifted right). The first encoder-decoder system 402, 404 is trained to output a policy (e.g. a probability distribution over possible output tokens), and a value score for the output. The second encoder-decoder system 412, 414 is trained to output the value score of the ground truth output sequence, determined using a privileged metric. Policy, π, and value losses, [symbol] _{π} and [symbol] ᵥ, are applied to the first system, e.g. as previously described, and a value loss, [symbol] _{vc}, determined using the privileged metric, is applied to the second system. An additional distillation loss e.g. an L2 loss, [symbol] , is applied between one or more final layers of each system (i.e. layers closest to the output(s)) with a stop gradient for the second system. That is this loss is not backpropagated into the second system so that the representation of the second system is not directly affected by [symbol] . The losses may be weighted relative to one another. After training only the first encoder-decoder system 402, 404 is needed to provide the trained value neural network.

A value neural network trained as described above may be used in the system of FIG. 1 or in another sequence-to-sequence transduction system. For example the trained value neural network may be used in a value-guided beam search system e.g. for neural machine translation, where a top-k hypotheses (candidate partial output sequences) may be selected for retention at least partially based on their respective values as determined by the trained value neural network. As another example a neural machine translation system may be used to generate a set of candidate output sequences that may then be ranked using their respective values as determined by the trained value neural network, and one of the candidates e.g. a candidate with a maximum value, selected as the output sequence for the system.

As previously described, in implementations the encoder neural network system 102 and decoder neural network system each include a transformer neural network subsystem comprising one or more transformer blocks, each including an attention or self-attention neural network layer configured to implement an attention, or self-attention, mechanism.

Generally, an attention mechanism maps a query and a set of key-value pairs to an output, where the query, keys, and values are all vectors. The output is computed as a weighted sum of the values, where the weight assigned to each value is computed by a compatibility function e.g. a dot product or scaled dot product, of the query with the corresponding key. For example an output of the attention mechanism may be determined as

$$softmax ( \frac{{QK}^{T}}{\sqrt{d}} )$$

V where d is a dimension of the key (and value) vector, where query vector Q=XW^{Q}, key vector K=XW^{K}, and value vector V=XW^{V}, with input sequence X and learned query matrix W^{Q}, learned key matrix W^{K}, and learned value matrix W^{V}. The output may be processed by one or more fully-connected, feed forward neural network layers. A layer norm operation may also be incorporated. The attention mechanism may implement multi-head attention, that is it may apply multiple different attention mechanisms in parallel. The outputs of these may then be combined, e.g. concatenated, with a learned linear transformation applied to reduce to the original dimensionality if necessary.

Some implementations of the sequence-to-sequence neural network system 100 use one or more hardware accelerator units to implement the transformer neural network subsystem. Example hardware accelerator units include a GPU (Graphics Processing Unit) or a TPU (Tensor Processing Unit). In such implementations, counter-intuitively, memory access can be a performance bottleneck, driven by the need to store and read keys and values from memory to enable fast incremental inference.

In these implementations, where multi-head attention is used, the memory access requirement is reduced by only computing a single set of keys and values per transformer block, shared across all the attention heads. This can yield a large speedup with only a small accuracy cost. The cost can be offset by increasing a number of weights used in the one or more fully-connected, feed forward neural network layers, e.g. by using a bigger internal hidden dimensionality.

Thus in some implementations processing the input sequence 122 using the encoder neural network system 102, to generate a latent representation 104 of the input sequence 122, and processing the latent representation 104 in combination with the partial output sequence 128, using the decoder neural network system 106, to generate the system output 112, comprises providing the input sequence 122 and the partial output sequence 128 to a hardware accelerator unit, processing, using the hardware accelerator unit, the input sequence 122 and the partial output sequence 128 using one or more transformer blocks of the encoder neural network system 102 and of the decoder neural network system 106. The one or more transformer blocks are configured to implement multi-head attention. Processing the input sequence 122 and the partial output sequence 128 includes storing to (external) memory and reading from the memory, keys and values for the multi-head attention. In implementations the processing includes only computing a single set of keys and values per transformer block, shared across all the attention heads. In some cases, memory accesses are a performance bottleneck, e.g., as a result of keys and values being stored in and read from the memory. Sharing a single set of keys and values per transformer block can reduce memory footprint and enable an almost linear speedup (e.g., in inference latency) with respect to the number of attention heads.

Also or instead the dimension d of the key (and value) vectors may be selected so that this matches a dimensionality of vectors as defined in hardware used by the hardware accelerator unit(s) to process the key (and value) vectors for the transformer blocks. This avoids expensive padding operations, further facilitating faster operation.

In some implementations code to perform the look ahead tree search, e.g. a Monte Carlo Tree Search (MCTS), may be batched with code to implement the sequence-to-sequence system 100, in particular to run on the same hardware acceleration unit and thereby facilitate efficient exchange of data. Other code, e.g. control and interface code, may run on a host processor.

Merely as one example, the encoder and decoder neural network systems may each comprise 6 transformer blocks, each with 16 attention heads. The next token probability distribution 108 may be provided by a policy head that projects linearly from a hidden dimensionality, e.g. 512, to a token vocabulary size, e.g. approximately 32K, followed by a softmax operation to output a distribution over the whole vocabulary; and the value 110 may be provided by a value head that projects linearly from the hidden dimensionality to a number of buckets, e.g. 500, followed by a softmax operation. The dimension of the keys and values may be e.g. 128.

The above described techniques may be applied to a wide range of different types of input sequence and output sequence. In implementations of the described techniques the tokens may represent, characterize, or encode any type of information in a sequence e.g. stream of data. The term “represent” is used, below, generally to refer to any way in which a token can encode part of a sequence. The tokens may include marker tokens, such as a start of sequence token, an end of sequence token, and a separator token (indicating a separation or break between two distinct parts of a sequence). The tokens may, but need not be, drawn from a defined vocabulary of tokens.

In some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g. for question answering, or for text completion. In some implementations the input sequence may represent text in a natural language and the output sequence may represent text in the same natural language, e.g. a longer item of text. For example in some implementations the input sequence may represent text in a natural language and the output sequence may represent the same text with a missing portion of the text added or filled in. For example the output sequence may represent a predicted completion of text represented by the input sequence. Such an application may be used, e.g. to provide an auto-completion function e.g. for natural language-based search. In some implementations the input sequence may represent a text in a natural language e.g. posing a question or defining a topic, and the output sequence may represent a text in a natural language which is a response to the question or about the specified topic.

As another example the input sequence may represent a first item of text and the output sequence may represent a second, shorter item of text e.g. the second item of text may be a summary of a passage that is the first item of text. As another example the input sequence may represent a first item of text and the output sequence may represent an aspect of the first item of text e.g. it may represent an entailment task, a paraphrase task, a textual similarity task, a sentiment analysis task, a sentence completion task, a grammaticality task, and in general any natural language understanding task that operates on a sequence of text in some natural language e.g. to generate an output that classifies or predicts some property of the text. For example some implementations may be used to identify a natural language of the first item of text, or of spoken words where the input is audio (as described below).

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

Some implementations may be used for speech recognition. In such applications the input sequence may represent spoken words and the output sequence may represent a conversion of the spoken words to a machine-written representation e.g. text. Then the input tokens may comprise tokens representing an audio data input including the spoken words e.g. characterizing a waveform of the audio in the time domain or in the time-frequency domain. The output tokens may represent words, wordpieces, characters, or graphemes of a machine-written, e.g. text, representation of the spoken input, that is representing a transcription of the spoken input.

Some implementations may be used for handwriting recognition. In such applications the input sequence may represent handwritten words, syllabograms or characters and the output sequence may represent a conversion of the input sequence to a machine-written representation e.g. text. Then the input tokens may comprise tokens representing portions of the handwriting and the output tokens may represent words, wordpieces, characters or graphemes of a machine-written, e.g. text, representation of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g. tokens characterizing a portion of a waveform of the speech in the time domain or in the time-frequency domain, or phonemes.

In some implementations the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (RoIs) in the image, optionally including one or more tokens for global image features. For example an image may be encoded using a neural network to extract RoI features; optionally (but not essentially) a token may also include data, e.g. a position encoding, representing a position of the RoI in the image. As another example, the tokens may encode color or intensity values for pixels of an image. As another example, some image processing neural network systems e.g. autoregressive systems, naturally represent images as sequences of image features. As another example, a transformer-based sequence-to-sequence neural network system as previously described may be used to process images instead of or as well as text (e.g. if trained on images instead of or as well as text).

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video e.g. described by the text, or providing a visual answer to a question posed by the text, or providing a visualization of a topic of the text. In another example the input sequence may comprise a sequence of input tokens representing an image or video, and the output tokens may represent words or wordpieces, or characters representing text e.g. for a description or characterization of the image or video, or providing an answer to a question posed visually by the image or video, or providing information on a topic of a topic of the image or video.

In some other implementations both the input sequence and the output sequence may represent an image or video, and both the input tokens and the output tokens may represent a respective image or video. In such implementations the method/system may be configured to perform an image or video transformation. For example the input sequence and the output sequence may represent the same image or video in different styles e.g. one as an image the other as a sketch of the image; or different styles for the same item of clothing.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

In some implementations the input sequence represents a sequence of actions to be performed by an agent e.g. a mechanical agent in a real-world environment implementing the actions to perform a mechanical task. The output sequence may comprise a modified sequence of actions e.g. one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence may comprise a sequence of predicted treatment. Then the input tokens may represent any aspect of the health of a patient e.g. data from blood and other medical tests on the patient and/or EHR (Electronic Health Record) data; and the output tokens may represent diagnostic information e.g. relating to a disease status of the patient and/or relating to suggested treatments for the patient, and/or relating to a likelihood of an adverse health event for the patient.

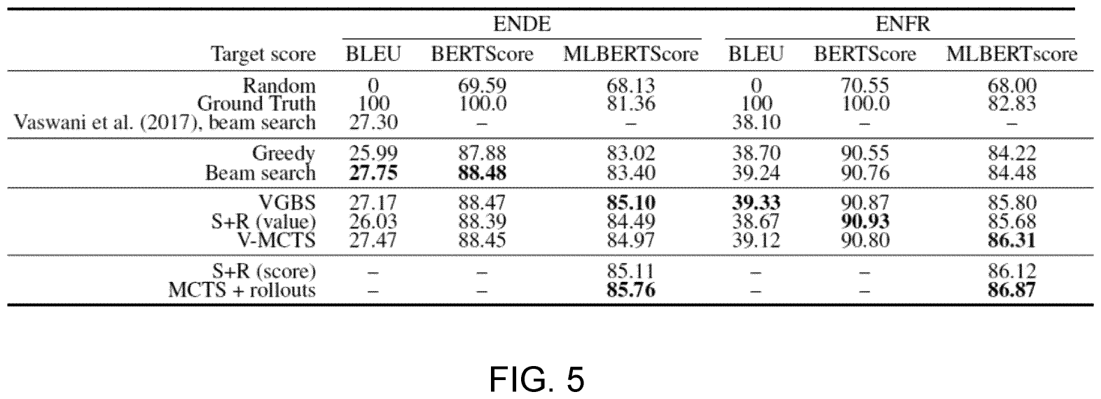

FIG. 5 compares the performance of some different neural machine translation systems including a sequence-to-sequence neural network system as described herein configured to perform natural language machine translation (“V-MCTS”). Overall it can be seen that V-MCTS performs competitively, and the algorithm has an advantage that it is not merely concerned with finding outputs with a high model likelihood, which are not always the most desirable natural language translations.

In FIG. 5 the systems are compared for English to German (“ENDE”) and English to French (“ENFR”) tasks, and are scored using three different approaches, BLEU, BERTScore, and MLBERTScore. The top row contains general metrics and a transformer baseline (Vaswani et al.). The second row shows the performance of supervised models with likelihood-based decodings. The third row shows results from value-based algorithms including, as well as V-MCTS, VGBS (value guided beam search), where the top-k in the beam are selected using the value neural network), and S+R (value), where a number of finished candidate sentences is sampled from the model and ranked according to their value. The final row shows results from S+R (score) where finished candidate sentences are ranked according to their score (e.g. BLEU score), and MCTS+rollouts where the value approximation for a node is replaced by a greedy rollout from the node until a terminal node is reached, the score of the finished sample becoming the value of the node.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method of generating an output sequence from an input sequence using a sequence-to-sequence neural network system,
wherein the sequence-to-sequence neural network system is configured to:
receive, as a system input, i) an input sequence comprising a sequence of input tokens and ii) a partial output sequence comprising zero, one, or more output tokens; and
process the system input to generate a system output defining a next token probability distribution over possible output tokens for a next output token to extend the partial output sequence;
the method comprising:
obtaining i) an input sequence comprising the sequence of input tokens and ii) an initial partial output sequence; and
extending the initial partial output sequence by performing a look ahead tree search of possible continuations of the initial partial output sequence guided by the sequence-to-sequence neural network system, until one or more termination criteria are met.

2. The method of claim 1 further comprising guiding the look ahead tree search using a value neural network, wherein guiding the look ahead tree search using a value neural network comprises processing both the input sequence and a partial output sequence associated with a node of the look ahead tree search to evaluate the node by generating a value for a partial output sequence associated with the node; and guiding the look ahead tree search using the value for the partial output sequence associated with the node.

3. The method of claim 2 wherein the sequence-to-sequence neural network system and the value neural network have each been trained, using training data pairs comprising a training input sequence and a training output sequence, to optimize a respective sequence transduction metric, and wherein a sequence transduction metric for the sequence-to-sequence neural network system and a sequence transduction metric for the value neural network are different.

4. The method of claim 1, wherein a root node of a search tree for the look ahead tree search represents the initial partial output sequence, wherein edges to child nodes on a path from the root node each represent a candidate continuation of the initial partial output sequence; and
wherein performing the look ahead tree search guided by the sequence-to-sequence neural network system comprises, for child nodes of the search tree:
processing the sequence of input tokens, the initial partial output sequence, and the candidate continuation of the initial partial output sequence, using the sequence-to-sequence neural network system, to define a next token probability distribution over possible output tokens for a next output token for extending the candidate continuation of the initial partial output sequence; and
using the next token probability distribution to expand the search tree.

5. The method of claim 4 further comprising performing the look ahead tree search of possible continuations of the partial output sequence guided by a value neural network,
wherein the value neural network is configured to process at least a partial output sequence to generate a value for the partial output sequence, and
wherein performing the look ahead tree search guided by a value neural network comprises:
evaluating candidate continuations of the initial partial output sequence, represented by nodes of the look ahead tree search, by processing the candidate continuation of the initial partial output sequence represented by a node using the value neural network to determine a value for the node.

6. The method of claim 5 wherein the value neural network is configured to process a combination of the input sequence and the partial output sequence; and wherein determining the value for a node comprises a combination of the input sequence and the candidate continuation of the initial partial output sequence represented by the node.

7. The method of claim 1, comprising:
performing the look ahead tree search of possible continuations of the initial partial output sequence to determine a plurality of complete candidate output sequences, wherein each complete candidate output sequence represents the complete sequence of input tokens;
scoring each of the complete candidate output sequences; and
selecting a candidate output sequence as the output sequence based on the scores.

8. The method of claim 1, further comprising:
selecting one of the possible continuations of the initial partial output sequence using the look ahead tree search;
extending the initial partial output sequence using the selected possible continuation to generate an extended partial output sequence; and
extending the extended partial output sequence by performing another look ahead tree search of possible continuations of the extended partial output sequence guided by the sequence-to-sequence neural network system.

9. The method of claim 8 comprising iteratively extending the extended partial output sequence by performing look ahead tree searches, until a complete version of the output sequence is generated.

10. The method of claim 1, wherein extending the initial partial output sequence by performing a look ahead tree search of possible continuations of the initial partial output sequence comprises:
generating a search tree probability distribution over the possible continuations of the initial partial output sequence using the look ahead tree search; and
selecting a continuation of the initial partial output sequence from the possible continuations using the search tree probability distribution.

11. The method of claim 4, wherein edges between the nodes have edge data comprising an action score for the edge, wherein the action score for an edge comprises a score for adding an output token to a candidate continuation of the initial partial output sequence represented by the node, and wherein
performing the look ahead tree search comprises traversing the search tree from the root node by selecting edges to be traversed based on a combination of the action scores for the edges and the next token probability distributions.

12. The method of claim 11 further comprising performing the look ahead tree search of possible continuations of the partial output sequence guided by a value neural network, and wherein using the next token probability distribution to expand the search tree comprises:
traversing the search tree from the root node until a leaf node is encountered;
expanding the leaf node by creating at least one new child node for the leaf node, wherein the new child node represents a candidate extension of the candidate continuation of the initial partial output sequence;
determining edge data for a new edge between the leaf node and the new child node by using the next token probability distribution to determine an action score for the new edge; and
evaluating the leaf node by processing the candidate continuation of the initial partial output sequence using the value neural network to determine a leaf node value.

13. The method of claim 12 further comprising updating the action scores for edges between the leaf node and the root node traversed during the search, using the leaf node value.

14. The method of claim 13 wherein updating the action score for an edge comprises setting the action score to a value determined by a maximum value amongst tree searches involving the edge performed during the look ahead tree search.

15. The method of claim 1, wherein processing the system input to generate a system output using the sequence-to-sequence neural network system comprises:
processing the system input using an encoder neural network system including a transformer neural network subsystem to generate a latent representation of the system input, and
processing a combination of the latent representation of the system input and the partial output sequence using a decoder neural network system including a transformer neural network subsystem to generate the system output.

16. The method of claim 15, wherein the processing comprises:
providing the input sequence and the partial output sequence to a hardware accelerator unit;
processing, using the hardware accelerator unit, the input sequence and the partial output sequence 128 using one or more transformer blocks of the encoder neural network system and of the decoder neural network system, wherein the one or more transformer blocks are configured to implement multi-head attention with a plurality of attention heads;
wherein processing the input sequence and the partial output sequence includes storing to memory and reading from the memory, keys and values for the multi-head attention; and
wherein the processing includes only computing a single set of keys and values per transformer block, shared across all the attention heads.

17. The method of claim 16 wherein the keys and values are defined by vectors, and further comprising matching a dimension keys and value vectors to a dimensionality of vectors defined in hardware of the hardware accelerator unit used to process the key and value vectors.

18. The method of claim 1, wherein the input tokens and the output tokens each represent words or wordpieces in a natural language.

19.-23. (canceled)

24. One or more computer-readable storage media storing instructions that when executed by one or more computers cause the one or more computers to perform operations comprising:
obtaining i) an input sequence comprising the sequence of input tokens and ii) an initial partial output sequence; and
extending the initial partial output sequence by performing a look ahead tree search of possible continuations of the initial partial output sequence guided by a sequence-to-sequence neural network system, until one or more termination criteria are met;
wherein the sequence-to-sequence neural network system is configured to:
receive, as a system input, i) an input sequence comprising a sequence of input tokens and ii) a partial output sequence comprising zero, one, or more output tokens; and
process the system input to generate a system output defining a next token probability distribution over possible output tokens for a next output token to extend the partial output sequence.

25. A system comprising one or more computers and one or more storage devices storing instructions that when executed by one or more computers cause the one or more computers to perform operations comprising:
obtaining i) an input sequence comprising the sequence of input tokens and ii) an initial partial output sequence; and
extending the initial partial output sequence by performing a look ahead tree search of possible continuations of the initial partial output sequence guided by a sequence-to-sequence neural network system, until one or more termination criteria are met;
wherein the sequence-to-sequence neural network system is configured to:
receive, as a system input, i) an input sequence comprising a sequence of input tokens and ii) a partial output sequence comprising zero, one, or more output tokens; and
process the system input to generate a system output defining a next token probability distribution over possible output tokens for a next output token to extend the partial output sequence.
